(19) United States
(12) Patent Application Publication
(10) Pub. No.: US 2025/0012685 A1
(43) Pub. Date: Jan. 9, 2025

(54) REFRIGERATION SYSTEM AND METHOD FOR LOADING SUCH A REFRIGERATION SYSTEM

(71) Applicant: L'Air Liquide, Societe Anonyme pour l'Etude et l’Exploitation des Procedes Georges Claude, Paris (FR)

(72) Inventors: Olivier GUIA, Sassenage (FR); Marc STORA, Sassenage (FR)

(73) Assignee: L'Air Liquide, Societe Anonyme pour l'Etude et l’Exploitation des Procedes Georges Claude, Paris (FR)

(21) Appl. No.: 18/710,070

(22) PCT Filed: Nov. 16, 2022
(86) PCT No.: PCT/EP2022/082088

§ 371 Date: May 14, 2024

(30) Foreign Application Priority Data
Nov. 19, 2021 (FR) FR2112254

(51) Int. Cl. G01N 1/42

(52) U.S. Cl. CPC G01N 1/42

(57) ABSTRACT

A refrigeration system comprising: a rod and a refrigeration unit that comprises a first thermal screen which at least partially defines a first thermal chamber and a second thermal screen which is located inside the first chamber and which is provided with means for thermally connecting the receiving space to the second thermal screen; wherein the first thermal screen comprises a first opening through which the rod passes, and the refrigeration unit comprises a first thermalization member that is arranged to selectively thermally connect a first portion of the rod to the first thermal screen. The invention also relates to a method for loading such a refrigeration system.

### CROSS REFERENCE TO RELATED APPLICATIONS

This application is a § 371 of International PCT Application PCT/EP2022/082088, filed Nov. 16, 2022, which claims the benefit of FR2112254, filed Nov. 19, 2021, both of which are herein incorporated by reference in their entireties.

### FIELD OF THE INVENTION

The present invention relates to the field of cryogenic refrigeration systems for bringing a sample to a temperature close to or less than one Kelvin.

### BACKGROUND OF THE INVENTION

A refrigeration system is known that comprises a refrigeration unit comprising a first thermal shield brought to a first temperature and defining a first thermal chamber. A second thermal shield is situated inside the first chamber and is brought to a second temperature less than the first temperature. A sample is cooled by placing it in a dedicated space of a loading rod. The rod is then introduced into the refrigeration unit in order to be thermally connected to the second shield.

Such a refrigeration system requires stopping the refrigeration unit and pressurizing (which operation is also referred to as “breaking the vacuum”) the first chamber when it is under vacuum. The rod is then introduced into the refrigeration unit and thermally connected to the second shield before the refrigeration system is restarted. Such a method is long, costly and energy-intensive. It does not therefore make it possible to easily and quickly bring the samples to be cooled to a low temperature.

One known solution consists of introducing a sample holder rod into the refrigeration unit, carrying out selective pre-cooling at one or more thermal shields. Pre-cooling is achieved while rotating the rod to make or break contact with the shields (the rod has a suitable geometry). When the sample is deposited in its cooled location, it is separated from the rod, which is removed from the unit. This configuration requires the provision of wiring and a structure that remains in place in the refrigeration unit.

Another known system is described in EP2313717A1. According to this principle, the loading rod bears movable elements that make it possible to allow or prevent heat exchange on introduction into the refrigeration unit. The rod remains in place in the refrigeration unit during its use for a measurement. However, this solution has a large footprint that limits the space for the samples.

### SUMMARY OF THE INVENTION

The invention particularly aims to facilitate the cooling of samples to cryogenic temperatures.

To this end, according to the invention a refrigeration system is provided comprising:
a loading rod provided with a holder or space for receiving a sample to be cooled; and
a refrigeration unit that comprises a first thermal shield that at least partially defines a first thermal chamber and a plate situated inside the first chamber and provided with a member for thermally connecting the receiving space to the plate. According to the invention, the first thermal shield comprises a first orifice for passing the rod through the first thermal shield (allowing the introduction or removal of the rod), and the refrigeration unit comprises a first thermalization member arranged to selectively thermally connect or disconnect a first portion of the rod to or from the first thermal shield when it is introduced into the thermal chamber.

It is therefore possible to load a sample into such a refrigeration system without having to interrupt operation, the time taken to bring the thermal shields to temperature is reduced, and the loading of samples is quicker and easier.

Advantageously, the thermalization member comprises at least one return element arranged to cause the thermalization member to switch from a first state in which the first portion is not thermally connected to the first shield to a second state in which the first portion is thermally connected to the first shield.

Particularly quick operation is obtained when the system comprises a first actuation device for switching the thermalization member from its second state to its first state.

The thermal stability and energy consumption of the system are improved when the first chamber is sealed and under vacuum and the sample is loaded through a lock chamber.

The energy consumption of the refrigeration system is improved when it comprises a shutter of the first orifice that is thermally connected to the first shield. Preferably, the system comprises a second actuation device for selectively switching the shutter between a first shut-off configuration of the first orifice and a second cleared configuration of the first orifice.

A cost-effective embodiment is obtained when the first actuation device and the second actuation device comprise a common drive unit and when a member for connecting the drive unit to the first actuation device and to the second actuation device comprises a first shaft rotatably mounted relative to the first shield. Preferably, the second actuation device then comprises a rotating connection between the shutter and the first shaft.

According to one preferred embodiment, the first thermalization member comprising a movable first jaw and a fixed second jaw, the first actuation device comprises a connecting rod/crank assembly in which the connecting rod comprises a first end rigidly connected to the shaft for rotation therewith and a second end connected via a first pivot to a third end of the crank, the fourth end of the crank being articulated on the movable jaw.

Advantageously, the first pivot comprises a slot for receiving a second shaft, the slot being arranged so that the rotation of the connecting rod is only transferred to the second shaft after the connecting rod has performed a first rotation of a first non-zero amplitude and the first amplitude is such that the first rotation causes the shutter to switch from its first configuration to its second configuration.

Advantageously, the rod comprises a first optical and/or electrical and/or fluidic communication network connected to a connection interface rigidly connected to the rod.

The application of the refrigeration system is particularly beneficial when the refrigeration unit is configured so that a first temperature of the first thermal shield is less than or equal to one Kelvin, and so that a second temperature of the plate is less than or equal to three hundred millikelvin.

An effective application is obtained when the refrigeration unit also comprises a first additional thermal shield that defines a second thermal chamber extending around the first thermal chamber, the second thermal chamber comprising a second orifice for passing the rod through the first additional thermal shield and a second thermalization member that is arranged to selectively thermally connect the first portion and the first additional thermal shield, a second additional thermal shield that defines a third thermal chamber extending around the second thermal chamber, the third thermal chamber comprising a third orifice for passing the rod through the second additional thermal shield and a third thermalization member that is arranged to selectively thermally connect the first portion and the second additional thermal shield, and a third additional thermal shield that defines a fourth thermal chamber extending around the third thermal chamber, the fourth thermal chamber comprising a fourth orifice for passing the rod through the third additional thermal shield.

The energy performance of the system is further improved when the system comprises an evacuation lock chamber. Preferably, the lock chamber comprises an exit sealably connected to the third additional thermal shield (to the last outer thermal shield).

The thermal stability and energy consumption of the system are further improved when the fourth chamber is sealed and under vacuum, the other chambers having the same vacuum atmosphere.

The energy consumption of the refrigeration system is further improved when the rod comprises a second portion capable of interacting with the thermalization member.

The invention also relates to a method for loading a sample into a refrigeration system as defined above, the method comprising the following steps, with the refrigeration system in operation:
placing the sample in the receiving space;
moving the rod through the first orifice so as to bring the first portion of the rod opposite the first thermalization member,
actuating the first thermalization member to thermally connect the first portion of the rod to the first thermal shield,
when the temperature of the first portion is substantially equal to the temperature of the first shield, actuating the first thermalization member to thermally disconnect the first portion from the first shield, and
moving the rod to thermally connect the rod to the second shield.

The method is even more effective when the refrigeration unit also comprises:
a first additional thermal shield that defines a second thermal chamber extending around the first thermal chamber, the second thermal chamber comprising a second orifice for passing the rod through the first additional thermal shield and a second thermalization member that is arranged to selectively thermally connect the first portion and the first additional thermal shield;
a second additional thermal shield that defines a third thermal chamber extending around the second thermal chamber, the third thermal chamber comprising a third orifice for passing the rod through the second additional thermal shield and a third thermalization member that is arranged to selectively thermally connect the first portion and the second additional thermal shield;
a third additional thermal shield that defines a fourth thermal chamber extending around the third thermal chamber, the fourth thermal chamber comprising a fourth orifice for passing the rod through the third additional thermal shield, the method comprising the additional steps of:
moving the rod through the fourth orifice and the third orifice so as to bring the first portion of the rod opposite the third thermalization member,
actuating the third thermalization member to thermally connect the first portion of the rod to the second additional thermal shield,
when the temperature of the first portion is substantially equal to the temperature of the second additional thermal shield, actuating the third thermalization member to thermally disconnect the first portion from the second additional thermal shield,
moving the rod into the second orifice so as to bring the first portion of the rod opposite the second thermalization member,
actuating the second thermalization member to thermally connect the first portion of the rod to the first additional thermal shield,
when the temperature of the first portion is substantially equal to the temperature of the first additional thermal shield, actuating the second thermalization member to thermally disconnect the first portion from the first additional thermal shield.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

Reference will be made to the appended drawings, in which:

FIG. 1 is a schematic plan view of a first embodiment of a refrigeration system according to the invention with the loading rod introduced into the refrigeration unit;

FIG. 2 is a schematic detail perspective view of a thermalization clamp of the refrigeration system in FIG. 1;

FIG. 3 is a schematic detail perspective view of the clamp in FIG. 2, a part of the actuation thereof, and a shutter;

FIG. 4 is a schematic detail plan view of the actuation of the clamp in FIG. 2;

FIG. 5 is a schematic detail perspective view of the shutter in FIG. 3;

FIG. 6 is a schematic detail plan view of a second configuration of the shutter in FIG. 3 and a first state of the clamp in FIG. 2;

FIG. 7 is a schematic detail plan view of a second configuration of the shutter in FIG. 3 and a second state of the clamp in FIG. 2;

FIG. 8 is a schematic plan view of a refrigeration unit according to a second embodiment of the invention with the rod outside the refrigeration unit;

FIG. 9 is a schematic detail plan view of a second embodiment of a refrigeration system according to the invention with the rod inside the refrigeration unit;

FIG. 10 is a partial schematic vertical cross-sectional view of a refrigeration unit according to a third embodiment of the invention with the rod outside the refrigeration unit;

FIG. 11 is a partial schematic vertical cross-sectional view of the refrigeration unit according to the third embodiment of the invention in a first configuration of introduction of the rod into the refrigeration unit;

FIG. 12 is a partial schematic vertical cross-sectional view of the refrigeration unit according to the third embodiment of the invention in a second configuration of introduction of the rod into the refrigeration unit;

FIG. 13 is a partial schematic vertical cross-sectional view of the refrigeration unit according to the third embodiment of the invention in a third configuration of introduction of the rod into the refrigeration unit.

### DETAILED DESCRIPTION OF THE INVENTION

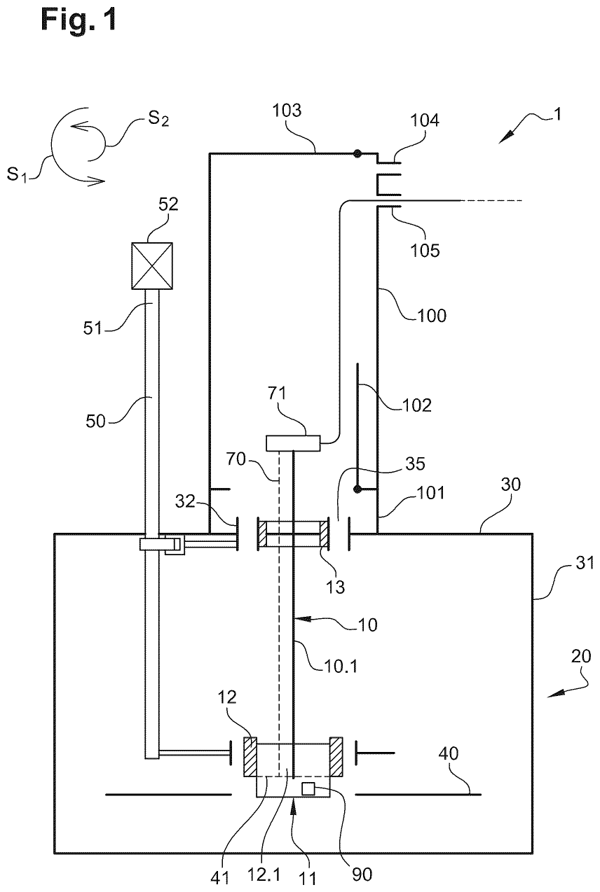

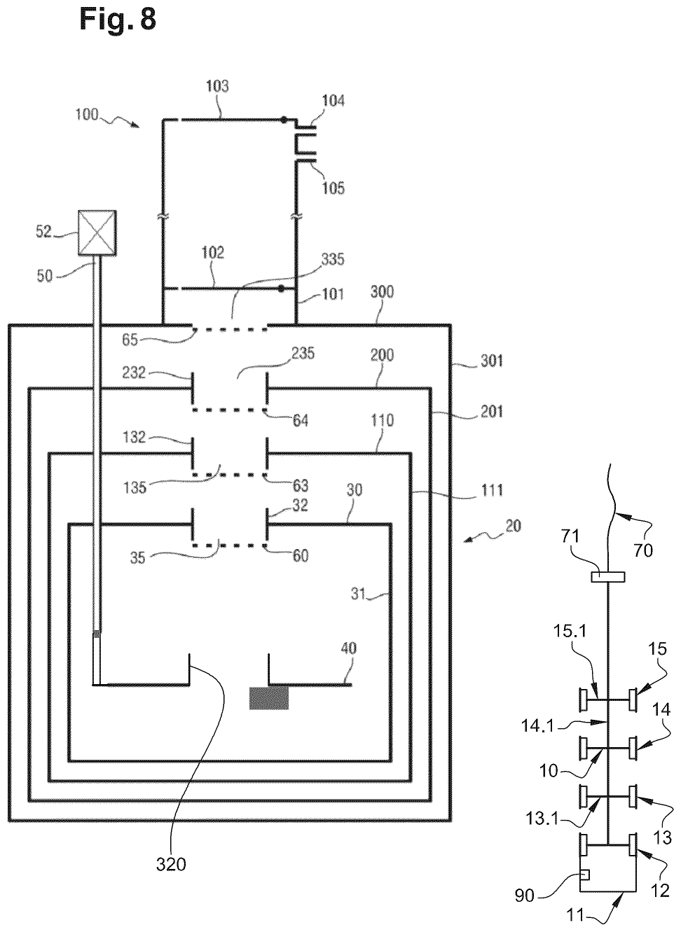

With reference to FIG. 1, the refrigeration system according to the invention and generally denoted 1 comprises a loading rod 10 comprising a wall or a set of walls defining at least one holder or space 11 for receiving a sample 90 to be cooled. The system 1 also comprises a refrigeration unit 20 that comprises a first thermal shield 30 that defines a first thermal chamber 31, here a cylindrical chamber 31. The shield 30 is connected to or contains one or more known cryogenic refrigeration systems, not shown, of the unit 20, such as for example a pumped helium bath, configured to keep the chamber 31 at a first cryogenic temperature, for example substantially equal to one Kelvin. The unit 20 also comprises a plate 40 situated inside the chamber 31 and connected to one or more other known sub-Kelvin cryogenic refrigeration systems, not shown, of the unit 20, such as for example a dilution refrigerator, configured to keep the plate at a second temperature less than the first temperature, for example less than or equal to 300 millikelvin, in particular between 500 and 300 millikelvin. As can be seen in FIG. 1, the plate 40 comprises a first recess 41, for example concave, intended to receive and if applicable come into contact with a conductive first portion or wall 12 (for example cylindrical) of the rod 10 that is thermally connected by conduction to the receiving holder 11, for example via a first solid disk 12.1. In other words, for example, the rod 10 holds at one end a structure defining a space or holder 11 (open or closed) for supporting or receiving at least one sample 90 to be cooled. The rod 10 can also comprise, at another end, a second wall or portion 13 identical to the wall 12 and connected to a non-thermally conductive (or less thermally conductive) body 10.1 of the rod 10. The wall 12, 13 is for example connected to the body 10.1 by a second solid disk 13.1 (cf. FIG. 8).

Here, solid disk is given to mean a wall or set of walls making it possible, for example, to form a sealed separation between the media that extend on its or their two opposite faces.

For example, the body of the rod 10 is made up (in a longitudinal direction) of a plurality of stacked portions: thermally conductive portions (portions or walls 12, 13) (for example made from copper, optionally gold-plated, brass, or aluminum) that are suitable for being thermalized (that is, cooled as described above and below) and one or more less thermally conductive longitudinal portions 10.1 between these conductive portions (for example insulating portions with little or no thermal conduction made up of glass fiber, carbon, titanium, etc., for example).

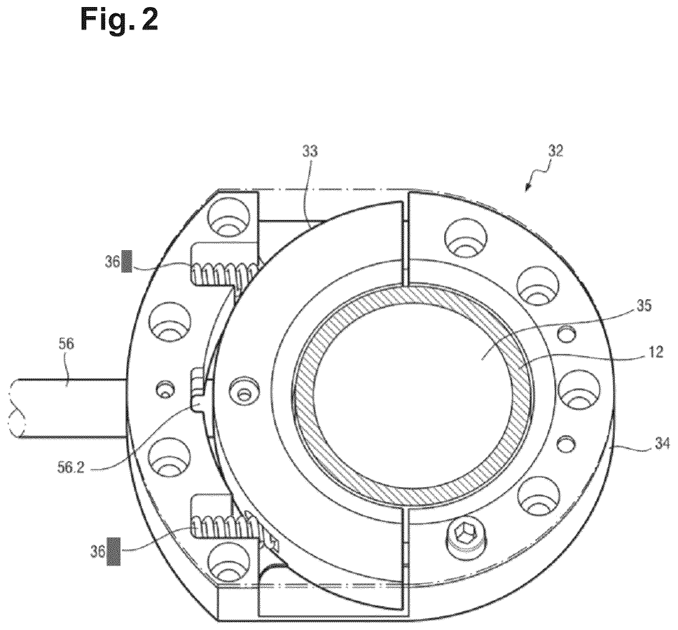

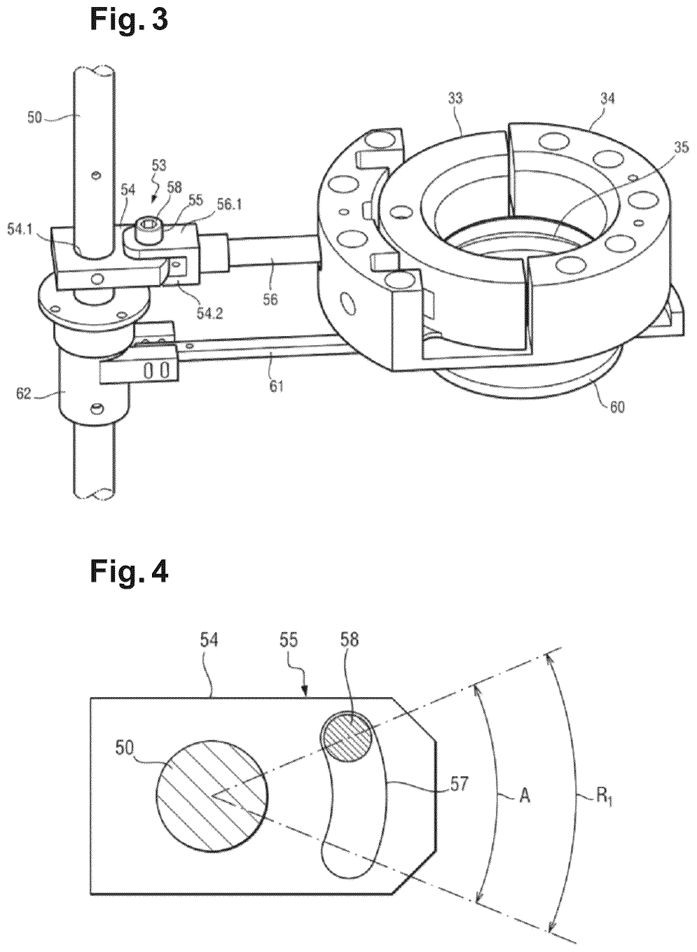

The unit 20 comprises a first thermalization clamp 32 mounted on the shield 30 and thermally connected to the shield 30. As can be seen in FIG. 2, the clamp 32 is mechanically rigidly connected to the chamber 31 and comprises a movable first jaw 33 and a preferably fixed second jaw 34 that define a first orifice 35 in the shield 30. The two jaws form a clamp system that can be actuated (opening/closing). As can be seen in FIG. 3, the jaw 33 is for example connected to a first shaft 50 rotatably mounted relative to the shield 30. The shaft 50 comprises an end 51 situated outside the chamber 31 and connected to an electric geared motor 52.

The first jaw 33 is connected to the shaft 50 by an actuation mechanism configured to allow the movement thereof between at least two positions or states. The actuation mechanism comprises, for example, a connecting rod and crank assembly 53.

In this example, the connecting rod 54 comprises a first end 54.1 rigidly connected to the shaft 50 for rotation therewith and a second end 54.2 connected by a first pivot 55 to a third end 56.1 of the crank 56. The fourth end 56.2 of the crank 56 is articulated on the jaw 33. As can be seen in FIG. 4, the pivot 55 comprises a slot 57 for receiving a second shaft 58 for connecting the connecting rod 54 to the crank 56. The slot 57 is arranged so that the rotation of the connecting rod 54 caused by the rotation of the shaft 50 is only transferred to the shaft 58 after the connecting rod 54 has performed a first rotation RI of a non-zero first amplitude A, here substantially equal to 45 degrees. The clamp 32 also comprises at least one and preferably two compression springs 36 and 36 that exert a force that tends to bring the first jaw 33 toward the second jaw 34. The spring or springs are arranged to push the jaw or jaws 33, 34 transversely toward the through-orifice to make thermal contact with the portion 12 of the rod.

The clamp 32 can therefore assume a first open state (or separated state) shown in FIG. 1, in which the rod 10 is not thermally connected to the shield 30 (the jaws 33 and 34 are not in contact with the wall 12) and a second closed (or together) state in which the rod 10 is thermally connected to the shield 30 when the jaw 33 clamps the wall 13 against the jaw 34 (FIG. 2 and FIG. 3).

The connecting rod/crank assembly 53 is an example of a first actuation device for actuating the clamp 32 that makes it possible, when it is actuated by the shaft 50, to selectively switch the clamp 32 from its closed state to its open state. The springs 36 make it possible to switch the clamp 32 automatically from its open state to its closed state when the actuator is not controlling the separation (opening) thereof. Of course, it could be envisaged that the closed (clamped) position or state could also be controlled by the actuator.

The refrigeration system thus comprises a controlled (actuated) clamping mechanism that makes it possible to make or break a thermal connection by contact (clamping) or lack of contact (release) around the rod 12. The thermalization member or members (jaws or clamps or other) can preferably move transversely to the rod and can be controlled to clamp it.

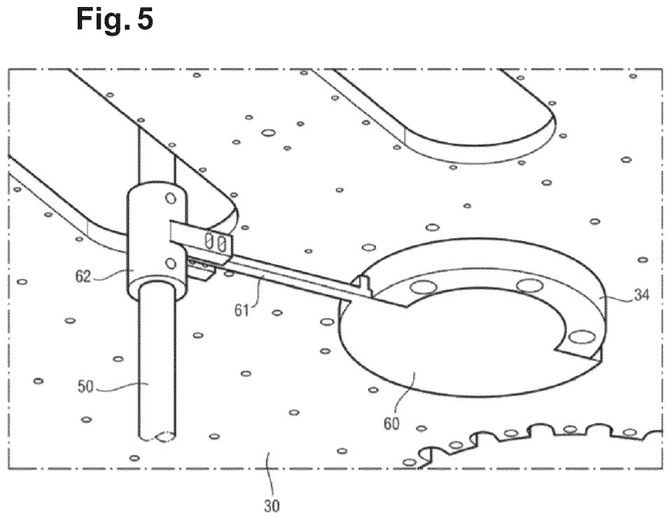

As can be seen in FIGS. 3 and 5, the unit 20 preferably also comprises a first movable shutter 60 configured to shut off or clear the orifice 35 depending on the position thereof. The shutter can also be moved by an actuation member.

For example, the shutter 60 comes into contact with the second jaw 34 when it is in its first configuration for shutting off the orifice 35 and is then thermally connected to the shield 30. The shutter 60 can be connected by means of a first arm 61 to a first bushing 62 rigidly connected to the shaft 50 for rotation therewith.

The rotation of the shaft 50 therefore makes it possible to switch the shutter 60 from its configuration for shutting off the orifice 35 to a second configuration for clearing (or not obstructing) the orifice 35, and vice versa. The assembly comprising the arm 61 and the bushing 62 forms a second actuation device for actuating the shutter 60.

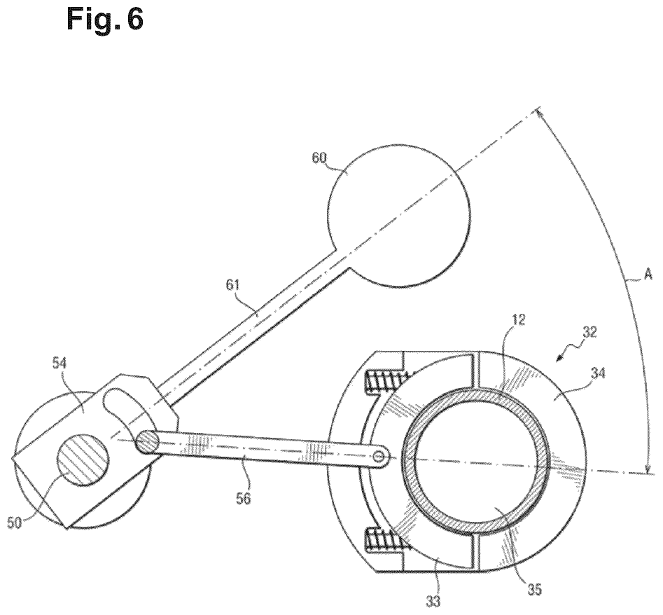

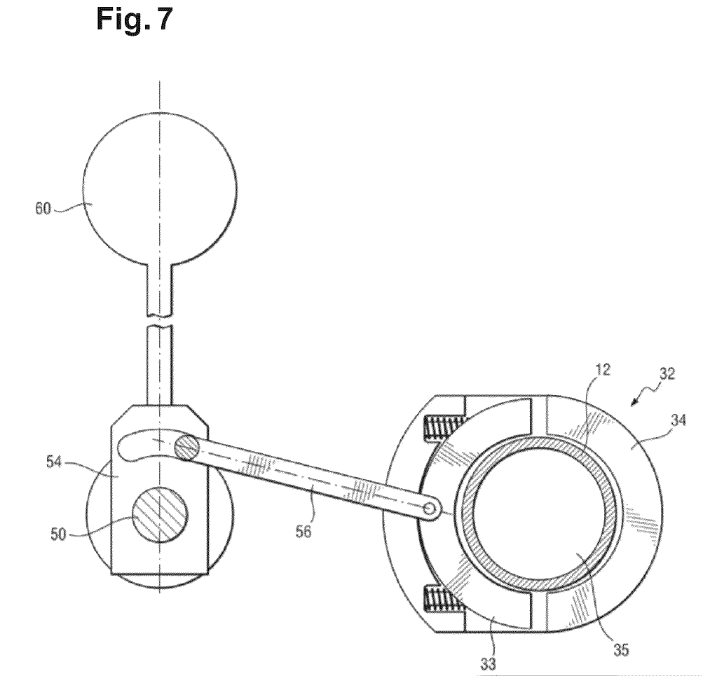

As can be seen in FIGS. 6 and 7, the amplitude A is such that the rotation RI of the shaft 50 causes the shutter 60 to switch from its configuration for shutting off the orifice 35 (FIG. 5) to its configuration for clearing the orifice 35 (FIG. 6), but without the clamp 32 switching from its closed state (FIG. 6) to its open state (FIG. 7).

The movement of the shutter 60 can be coupled to the movement of the thermalization member 32 and/or vice versa (dependent or linked movement). The loading rod 10 is lighter and easier to handle due to the proposed configuration of the clamps 32. The movable thermalization members 32 and their actuator are mounted in the refrigeration unit.

Finally, the rod 10 preferably comprises or bears an optical and/or electrical and/or fluidic communication network 70 connected to a connection interface 71 rigidly connected to the rod 10.

Preferably, the chamber 31 can be sealed and under vacuum when the system is in operation. Likewise, this first chamber 31 can be housed in an outer chamber under vacuum. The system 1 can then comprise an evacuation lock chamber 100 the exit 101 of which comprises a movable or removable door 102. The exit 101 is sealably connected to the shield 30 and faces the orifice 35. The lock chamber 100 comprises, in a known manner, an entrance door 103, an evacuation/pressurization port 104 and a port 105 connecting the interface 71 to the outside of the lock chamber 100.

It is possible to bring a sample 90 to the temperature of the plate 40 without having to interrupt the operation of the refrigeration system 1, by following the steps described below.

According to a first step, the sample 90 is placed in the space 11 (receiving holder). If the first chamber 31 is under vacuum, the rod 10 is introduced into the lock chamber 100 and the lock chamber 100 is evacuated (second step). According to a third step, the geared motor 52 is controlled so that the shaft 50 performs a rotation of a pre-determined amplitude, for example greater than 45 degrees (here, an amplitude of 90 degrees) in a first direction S1. Such a rotation of the shaft 50 causes the shutter 60 to switch to its configuration in which the orifice 35 is clear and causes the clamp 32 to switch to its open state. According to a fourth step, the door 102 is opened and the rod 10 is moved through the orifice 35 until the wall 12 thereof is opposite the jaws 33 and 34. According to a fifth step, a pre-determined rotation of the shaft 50, for example substantially equal to 45 degrees, is controlled in a second direction S2 opposite to the first direction S1 so as to cause the clamp 32 to switch to its closed state, but without the shutter 60 switching to its shut-off configuration. The wall 12 is then thermally connected to (in contact with) the shield 30 and this connection is maintained until the temperature of the wall 12 is substantially equal to the temperature of the shield 30, i.e. one Kelvin, for example. According to a sixth step, a pre-determined rotation of the shaft 50, for example 45 degrees, is controlled in the first direction S1 so as to cause the clamp 32 to switch to its open state, while keeping the shutter 60 in its cleared configuration. This has the effect of breaking the thermal connection (contact) between the wall 12 and the first shield. According to a seventh step, the rod 10 is moved until the wall 12 is placed in the recess 41 and the rod 10 is thus thermally connected to the plate 40. The plate 40 can also comprise a movable clamp system 320 (thermalization member) to make or break thermal contact between the plate 40 and the portion 12 thermally connected to the holder 11 for receiving the object 90 to be cooled.

Advantageously, a pre-determined rotation of the shaft 50, for example substantially equal to 45 degrees, is controlled in the second direction S2 so as to cause the clamp 32 to switch to its closed state, without the shutter 60 switching to its shut-off configuration (eighth step). The wall 13 is then thermally connected to the shield 30, which slows down the loss of cold energy by conduction from the plate 40 via the rod 10. The second disk 13.1 then acts as a shut-off device for the orifice 35 and contributes to the insulation of the inside of the chamber 31 from the outside of the chamber 31.

The sample 90 is removed from the unit 20 by performing the steps above in reverse.

Elements that are identical or similar to those described above have the same numerical reference sign in the following description of a second embodiment of the invention.

According to a second embodiment of the invention shown in FIG. 8, the unit 20 comprises a first additional thermal shield 110, thermalized for example to four Kelvin by the second stage of a pulse tube, that defines a second thermal chamber 111 extending around the chamber 31. The unit 20 also comprises a second additional thermal shield 200, thermalized for example to 50 Kelvin by the first stage of a pulse tube, that defines a third thermal chamber 201 extending around the second thermal chamber 111, together with a third additional thermal shield 300, at ambient temperature (that is, close to 300 Kelvin), that defines a fourth thermal chamber 301 extending around the third thermal chamber 201.

The chambers are thus nested one inside another like “Russian dolls”.

The outermost chamber 301 is preferably sealed and, in operating conditions, is under vacuum at a pressure less than or equal to one ten-thousandth of a millibar.

The chamber 111 comprises a second thermalization member or clamp 132, identical to the clamp 32, that is thermally connected to the shield 110. The clamp 132 defines a second orifice 135 through which the rod 10 passes.

The chamber 201 comprises a third thermalization clamp 232, identical to the clamp 32, that is thermally connected to the shield 200. The clamp 232 defines a third orifice 235 through which the rod 10 passes.

The chamber 301 comprises a fourth orifice 335 through which the rod 10 passes. The clamps 132 and 232 are actuated by the geared motor 52 via the shaft 50.

The shields 110 and 200 are connected to known cryocoolers, not shown, of the unit 20 so as to be kept respectively at pre-determined temperatures, for example a third temperature substantially equal to four Kelvin, and a fourth temperature substantially equal to 50 Kelvin. The temperature of the shield 300 is ambient temperature, here substantially equal to 300 Kelvin.

The unit 20 also comprises a second shutter 63 for shutting off the orifice 135, a third shutter 64 for shutting off the orifice 235, and a fourth shutter 65 for shutting off the orifice 335. The shutters 63, 64, and 65 are identical to the shutter 60 and are respectively mounted on and thermally connected to the shields 110, 200 and 300. The shutters 63, 64, and 65 are actuated by the geared motor 52 via the shaft 50.

According to this second embodiment, the exit 101 of the lock chamber 100 is sealably connected to the shield 300 and faces the orifice 335.

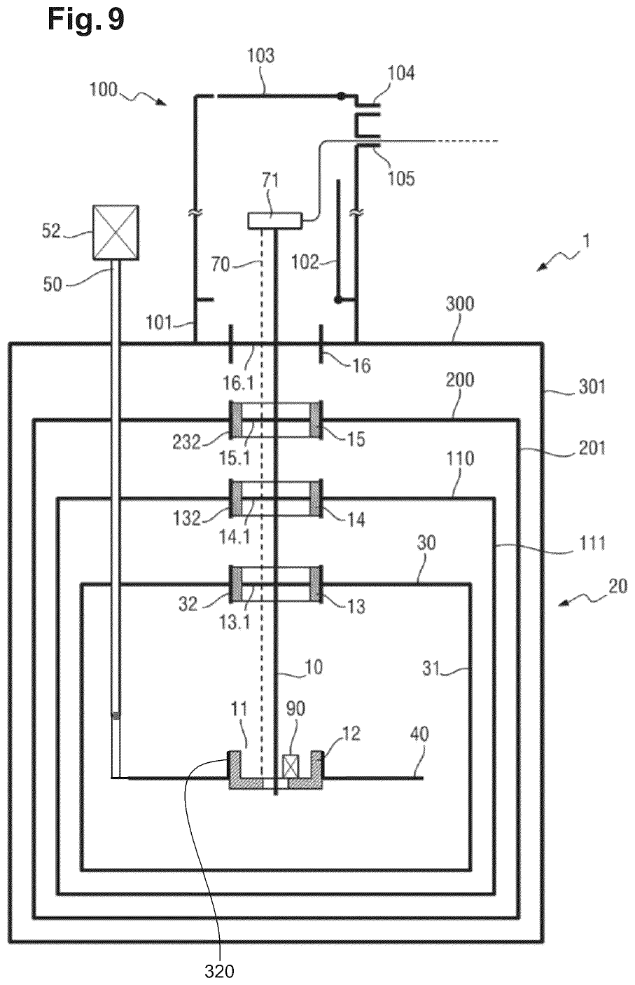

As can be seen in FIG. 9, the rod 10 comprises a first wall 12, a second wall 13, a third wall 14, a fourth wall 15, and a fifth wall 16 that are respectively connected to the rod 10 by portions or disks (for example the disks 14.1, 15.1, and 16.1).

The system 1 is then used by implementing the following additional steps, prior to steps three to eight described above with reference to the first embodiment of the invention.

Following the second step of evacuating the lock chamber 100, the rod 10 is moved through the orifices 335 and 235 so as to bring the wall 12 opposite the clamp 232. The geared motor 52 is controlled to actuate the clamp 232 and thermally connect the wall 12 to the shield 200. This also causes the wall 13 to be connected to the shield 300 and the disk 13.1 acts as a shut-off device for the orifice 335. When the temperature of the wall 12 is substantially equal to the temperature of the shield 200 (here, 50 Kelvin), the geared motor 52 is controlled to actuate the clamp 232 and break the thermal connection between the wall 12 and the shield 200. This also breaks the connection between the wall 13 and the shield 300. The rod 10 is then moved into the next orifice 135 so as to bring the wall 12 opposite the clamp 132. The geared motor 52 is controlled to actuate the clamp 132 to thermally connect the wall 12 to the shield 110. This also causes the wall 13 to be connected to the shield 200 and the wall 14 to be connected to the shield 300. The disk 13.1 then acts as a shut-off device for the orifice 235 and the disk 14.1 acts as a shut-off device for the orifice 335. When the temperature of the wall 12 is substantially equal to the temperature of the shield 110 (here, four Kelvin), the geared motor 52 is controlled to actuate the clamp 132 and break the thermal connection between the wall 12 and the shield 110. This also breaks the connection between the wall 13 and the shield 200 and the connection between the wall 14 and the shield 300.

Steps three to eight described with reference to the first embodiment are then carried out.

FIG. 9 shows the final step of the second embodiment of the method according to the invention. At the end of this step, the portion or wall 12 is thermally connected to the shield 40 having been cooled four times in succession from the outside to the inside. The disks 13.1, 14.1, 15.1, and 16.1 of the rod 10 act as shut-off devices for the orifices 35, 135, 235, and 335 respectively, and improve the relative thermal insulation of the chambers 31, 111, 201, and 301.

In other words, the device comprises a set of actuation mechanism(s) that control(s) the opening or closing of the clamps 32 and the shutting off or clearing of the orifices by the shutters 60, 63, 64, 65 sequentially (or simultaneously if applicable) to keep the orifices closed and prevent or limit the ingress of heat during the operations to introduce/remove the rod 10 with respect to the chamber or chambers. Preferably, in each configuration, the orifice or orifices are shut off either by a wall of the rod (disks 13.1, 14.1, 15.1, and 16.1) or by a shutter 60.

This allows pre-cooling of the lower wall 12 of the rod 10, which is thermally connected to the holder 11 for receiving samples to be cooled, in order to cool the samples before they are accommodated on the plate 40.

When the rod 10 is fully introduced into the refrigeration unit, the samples are accommodated on the plate 40 and kept at the coldest temperature. The rod 10 can remain in place in the refrigeration unit during the measurements and operation (holder 11 remains rigidly connected to the rod 10). The other walls 13.1, 13, 14.1, 14, 15.1, 15 situated higher up along the rod 10 form devices for shutting off the orifices of the shields that limit heat ingress via the thermalization members 32 that clamp them.

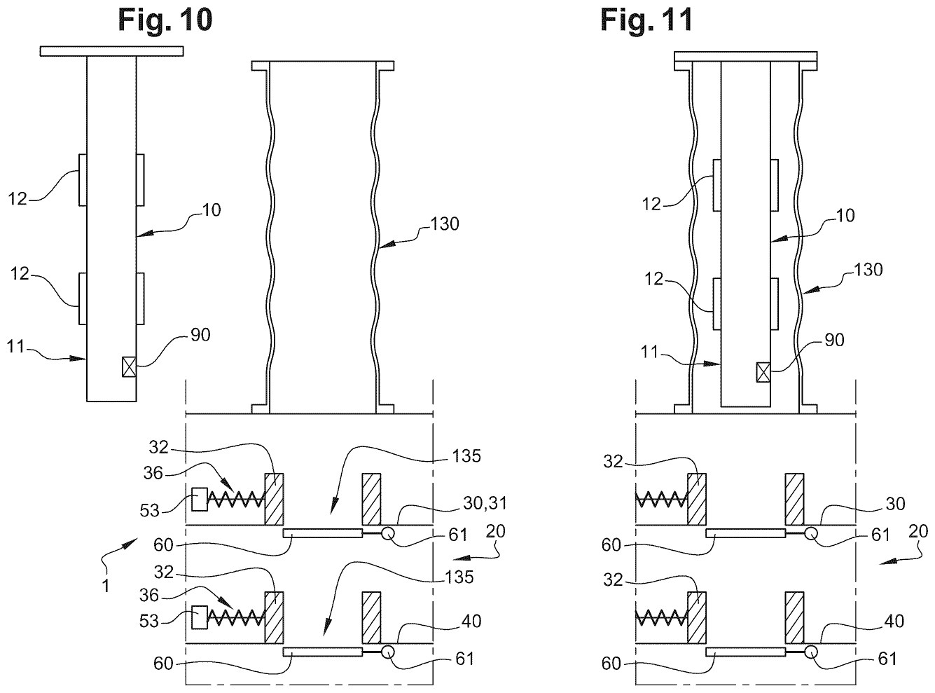

FIGS. 10, 11, 12, and 13 illustrate another variant embodiment. Elements identical to those described above are denoted by the same numerical reference signs.

As schematically shown, the refrigeration unit 20 comprises on or more thermal shields 30 rigidly connected to respective chambers 31. The chamber or set of chambers houses a plate 40 intended to accommodate the receiving holder 11 of the rod 10 provided with the sample or samples 90 to be cooled. In particular, the plate 40 can also be provided with a thermalization member 32 movable on the plate 40 between a first state in which it does not make contact or a thermal connection with the portion 12 of the rod to cool the holder 11 and a second state in which it makes contact and a thermal connection with the portion 12 of the rod 10 to cool the holder 11.

The holder 11 borne by the rod 10 can be delimited by a thermally conductive wall rigidly connected to the rod 10 and thermally connected to the adjacent conductive portion or wall 12. This holder 11 can comprise or form a tube or concave recipient borne by the end of the rod 10.

In the configuration in FIG. 10, the rod 10 is outside the refrigeration unit (outside the chambers). In this example, the rod 10 comprises two conductive portions 12 spaced along the rod 10, one of which is thermally connected to the holder 11. In this configuration, the two orifices 35, 135 of the thermal shields 30 and optionally the receiving zone of the plate 40 are closed by respective shutters 60. The orifices 35, 135 and the receiving zone of the plate 40 are aligned.

The assembly can be placed in an outer casing (optionally under vacuum) provided with an entrance for access to the orifices 35, 135. As schematically shown, the entrance can be delimited by a bellows 130 (which can form part of a lock chamber, for example).

As illustrated in FIG. 11, at the start of the introduction of the rod 10 into the refrigeration unit 20, the lower end of the rod 10 is placed in the bellows 130 and its upper end can if applicable be in sealed contact with the upper end of the bellows 130.

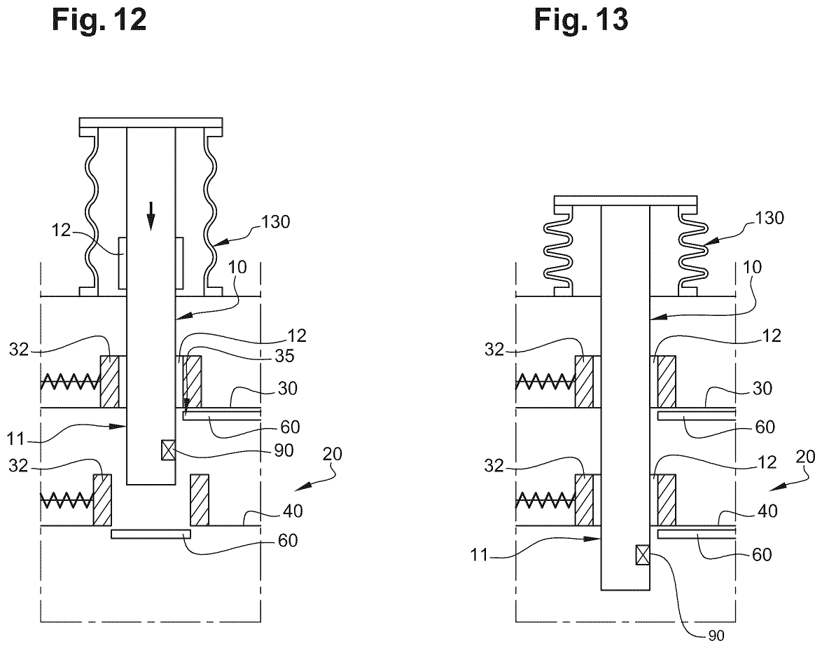

The rod 10 is moved toward the inside of the refrigeration unit 20 (for example through a door of the outer casing) until the portion 12 reaches the first thermal shield 30 (cf. FIG. 12).

As described above, the shutter 60 is moved (actuation device 61) to open the orifice 35. The rod 10 is moved so as to bring the portion 12 opposite the thermalization member 32. The thermalization member 32 (clamps or jaws, for example) is actuated by the actuation device 53 to come into contact with the portion 12 of the rod 10.

When the thermalization of the holder 11 to the target temperature is complete, the rod 10 is introduced further inside the refrigeration unit 20. The bellows 130 is further compressed. The end portion 12 of the rod 10 reaches the plate 40 where it is thermally connected in the same way as before, preferably at a lower temperature (movement of a shutter 60 and/or a thermalization member 32) (cf. FIG. 13).

As a variant, the end portion 12 of the rod 10 could be directly thermally connected by contact with an element rigidly connected to the plate 40. The holder 11 can be further cooled to the lower temperature of the plate 40 via the portion 12 of the rod 10.

At the same time, the other portion 12 of the rod 10 situated higher up is thermalized by the preceding thermal shield 30 and closes the corresponding orifice 35. The structure of the rod 10 thus makes it possible to close the different orifices 35, 135 of the chambers to prevent heat ingress toward the plate 40.

Of course, the invention is not limited to this schematic example either. The number of portions 12 of the rod 10 to be thermalized and the number of thermalization thermal shields 30 can thus be different. As illustrated, a plurality of portions 12 of the rod 10 can be thermalized to different temperature levels with the respective thermal shields at the same time.

According to the invention, the movable mechanical connections (movable thermalization members 32) are rigidly connected to the shields and to the plate 40 if applicable, and not to the rod 10. This makes it possible to maximize the space available on the loading rod 10, its footprint and its mass. The rod 10 is easy to move (introduce and remove) whatever the temperature and vacuum in the refrigeration unit 20 and without having to stop it.

The invention can advantageously be applied to a helium-3/helium-4 dilution refrigerator. In this case, a pulse tube, a cryogenerator (cryocooler), or any other appropriate cold source, can be used to thermalize the chambers 111 and 201, the chamber 31 being thermalized for example by a pumped helium bath (or any other cold source such as a cryocooler, for example) and the plate 40 accommodating the mixing chamber of the dilution refrigerator. A sample to be cooled to the temperature of the plate 40 can then be loaded easily by means of the invention, without stopping the operation of the system 1.

Of course, the invention is not limited to the embodiment described but encompasses any variant that falls within the scope of the invention as defined by the claims.

In particular:
although here the temperature of the first shield is substantially equal to one Kelvin, the invention also applies to other values of the first temperature, such as for example temperatures of between six and 12 Kelvin;
although here the walls of the rod are cylindrical, the invention also applies to other types of portion for thermal connection of the rod to the thermalization members, such as for example copper rods, or walls with a square or any other shape, the orifice of the thermalization clamps being adapted accordingly;
although here the system comprises thermalization clamps, the invention also applies to other thermalization devices such as for example cams or conductive brushes or any other suitable device;
although here the first shaft is connected to an electric geared motor, the invention also applies to other types of drive unit common to the first and second actuation devices such as for example a pneumatic, hydraulic, linear, or other actuator;
although here the shutter is thermally connected to the first shield when it is in its shut-off configuration, the invention also applies to other types of thermal connection between the shutter and the shield such as for example a permanent connection using a copper braid;
although here the rod comprises an optical, electrical, and fluidic communication network, the invention also applies to a rod that comprises just one or just two of these communication networks;
the rod can be moved into and out of the refrigeration unit using an actuator. This actuator will then advantageously be linked to the movements of the common drive unit in order to obtain complete automation of the operations to load/unload a sample into/from the refrigeration system of the invention;
although here the shutter is switched from its open configuration to its closed configuration using a second actuation device, the invention also applies to other types of second actuation device such as a dedicated linear actuator, or even no second actuation device in the case of a rotatably mounted shutter that would be pushed by the rod;
although here the clamp comprises a spring to change the state of the clamp, the invention also applies to other types of return element such as for example a magnet, a weight distribution taking advantage of gravity, spring washers, or an elastomeric element;
the invention can be applied to any other sub-Kelvin refrigeration system, such as a Joule-Thompson helium-3 or helium-4 refrigerator, a helium-3 refrigerator, or an adiabatic demagnetization refrigerator;
in one variant embodiment, in particular on introduction of the rod into the chambers, all of the walls of the rod are not necessarily thermalized by clamps: just one or just part of the walls can thus be thermalized by a clamp, and in particular just the end wall 12 could be thermalized;
mention is made here of a vacuum at a pressure of less than one ten-thousandth of a millibar, but the invention could also be implemented with a vacuum at a pressure less than one hundredth of a millibar;
the thermalization member or members (clamp(s) or other) are movably mounted on the chamber between at least two positions or states making contact (thermal connection) or breaking contact (no contact) between the portion of the rod and the cooled thermal shield;
the thermalization member is movably mounted relative to the through-orifice, for example movably mounted on the thermal shield or on any other fixed part of the refrigeration unit;
the thermalization member is movably mounted on the refrigeration unit, for example on the thermal shield level with the through-orifice, in order to selectively thermally connect or disconnect the portion of the rod and the thermal shield when the portion is situated level with the through-orifice (for example in the through-orifice);
at least part of the thermalization member is mounted so that it can move transversely to the longitudinal axis of the rod when the rod is introduced into the thermal chamber, in particular into the through-orifice;
the refrigeration unit comprises a controlled actuator (for example the first actuation device) that controls the position of the thermalization member (first and/or second state);
the actuator that moves the thermalization member is independent of the rod and in particular separate from the rod;
the jaw or jaws take the form of a ring portion, for example a half-ring arranged around the through-orifice;
preferably, a single jaw can be moved and actuated transversely to the orifice in order to make or break the thermal connection but the two jaws can be mounted so that they can be moved and actuated to either clamp (thermal contact) or release (no thermal contact).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-21. (canceled)

22. A refrigeration system comprising:
a loading rod provided with a holder for receiving a sample to be cooled; and
a refrigeration unit comprising a first thermal shield that at least partially defines a first thermal chamber and a plate situated inside the first thermal chamber, the plate comprising a recess configured to receive the receiving holder of the rod and make a thermal connection between the receiving holder and the plate, the first thermal shield comprising a first orifice through which the rod passes, the rod being able to be introduced into or removed from the first thermal chamber via the first orifice, and the refrigeration unit comprises a first thermalization member configured to allow a heat exchange between a first portion of the rod and the first thermal shield when the rod is introduced into the first thermal chamber, characterized in that at least part of the first thermalization member is movable in order to selectively thermally connect or disconnect the first portion of the rod and the first thermal shield.

23. The refrigeration system as claimed in claim 22, wherein the first thermalization member is movably mounted on the first thermal chamber between a first state in which it does not make contact or a thermal connection between the first portion of the rod and the first thermal shield, and a second state in which it makes contact and a thermal connection between the first portion of the rod and the first thermal shield.

24. The refrigeration system as claimed in claim 22, wherein the first thermalization member comprises a movable first jaw and a fixed or movable second jaw.

25. The refrigeration system as claimed in claim 22, further comprising a first actuation device configured to switch the first thermalization member from its second state to its first state.

26. The refrigeration system as claimed in claim 22, wherein the first thermalization member comprises at least one return element arranged to cause the first thermalization member to switch from the first state in which the first portion is not thermally connected to the first thermal shield to the second state in which the first portion is thermally connected to the first thermal shield.

27. The refrigeration system as claimed in claim 22, further comprising a shutter for shutting off the first orifice.

28. The refrigeration system as claimed in claim 27, wherein the shutter is thermally connected to the first thermal shield.

29. The refrigeration system as claimed in claim 27, further comprising a second actuation device configured to selectively switch the shutter between a first shut-off configuration of the first orifice and a second cleared configuration of the first orifice.

30. The refrigeration system as claimed in claim 29, wherein the first actuation device and the second actuation device comprise a common drive unit.

31. The refrigeration system as claimed in claim 30, wherein a member for connecting the drive unit to the first actuation device and to the second actuation device comprises a first shaft rotatably mounted relative to the first shield.

32. The refrigeration system as claimed in claim 31, wherein the second actuation device comprises a rotating connection between the shutter and the first shaft.

33. The refrigeration system as claimed in claim 29, wherein the first actuation device comprises a connecting rod and crank assembly.

34. The refrigeration system as claimed in claim 22, wherein the rod comprises an optical and/or electrical and/or fluidic communication network connected to a connection interface rigidly connected to the rod.

35. The refrigeration system as claimed in claim 22, wherein the refrigeration unit is configured so that, during operation, a first temperature of the first thermal shield is less than or equal to a first pre-determined temperature, for example one Kelvin, and so that a second pre-determined temperature of the plate is less than the first temperature of the first thermal shield and for example equal to 300 millikelvin.

36. The refrigeration system as claimed in claim 22, wherein the loading rod comprises along its length a plurality of separate portions suitable for interacting with the first thermalization member and in particular a second portion suitable for interacting with the first thermalization member.

37. The refrigeration system as claimed in claim 22, wherein the refrigeration unit comprises a plurality of thermal shields and in particular at least one additional thermal shield in addition to the first thermal shield, the thermal shields defining respective thermal chambers extending one around another, each chamber comprising an orifice through which the rod passes and a thermalization member that is arranged to make it possible to selectively thermally connect a portion of the rod and the thermal shield, the through-orifices being aligned, and the rod being able to be introduced into or removed from the thermal chambers via the aligned orifices.

38. The refrigeration system as claimed in claim 37, wherein, in the operating configuration of the refrigeration system, the loading rod is accommodated in the refrigeration unit, the receiving holder of the rod being thermally connected to the plate, at least some of the through-orifices of the thermal shields being closed by portions of the rod in contact with and thermally connected to the corresponding thermalization members.

39. The refrigeration system as claimed in claim 22, wherein the refrigeration unit comprises:
a first additional thermal shield that defines a second thermal chamber extending around the first thermal chamber, the second thermal chamber comprising a second orifice through which the rod passes and a second thermalization member that is arranged to selectively thermally connect the first portion and the first additional thermal shield;
a second additional thermal shield that defines a third thermal chamber extending around the second thermal chamber, the third thermal chamber comprising a third orifice through which the rod passes and a third thermalization member that is arranged to selectively thermally connect the first portion and the second additional thermal shield;
a third additional thermal shield that defines a fourth thermal chamber extending around the third thermal chamber, the fourth thermal chamber comprising a fourth orifice through which the rod passes.

40. The refrigeration system as claimed in claim 22, further comprising the following steps, with the refrigeration system in operation;
placing a sample in the receiving holder of the rod;
moving the rod through the first orifice so as to bring the first portion opposite the first thermalization member,
actuating the first thermalization member to thermally connect the first portion to the first thermal shield,
when the temperature of the first portion is substantially equal to the temperature of the first shield, actuating the first thermalization member to thermally disconnect the first portion from the first shield,
moving the rod to thermally connect the first portion of the rod to the next thermal shield or to the plate.

41. The refrigeration system as claimed in claim 40, wherein the rod comprises along its length a plurality of portions configured to be placed in contact with and thermally connected to or disconnected from the thermal shields of the refrigeration unit, the method comprising a plurality of movements of the rod through the orifices so as to bring the portions opposite thermalization members and a plurality of actuations of the thermalization members so as to thermally connect the portions to the thermal shields.

42. The refrigeration system as claimed in claim 40, wherein, the refrigeration unit also comprises:
a first additional thermal shield that defines a second thermal chamber extending around the first thermal chamber, the second thermal chamber comprising a second orifice through which the rod passes and a second thermalization member that is arranged to selectively thermally connect the first portion and the first additional thermal shield;
a second additional thermal shield that defines a third thermal chamber extending around the second thermal chamber, the third thermal chamber comprising a third orifice through which the rod passes and a third thermalization member that is arranged to selectively thermally connect the first portion and the second additional thermal shield;
a third additional thermal shield that defines a fourth thermal chamber extending around the third thermal chamber, the fourth thermal chamber comprising a fourth orifice through which the rod passes,
the method comprises the additional steps of:
moving the rod through the fourth orifice and the third orifice so as to bring the first portion opposite the third thermalization member;
actuating the third thermalization member to thermally connect the first portion to the second additional thermal shield;
when the temperature of the first portion is substantially equal to the temperature of the second additional thermal shield, actuating the third thermalization member to thermally disconnect the first portion from the second additional thermal shield;
moving the rod into the second orifice so as to bring the first portion opposite the second thermalization member;
actuating the second thermalization member to thermally connect the first portion to the first additional thermal shield; and
when the temperature of the first portion is substantially equal to the temperature of the first additional thermal shield, actuating the second thermalization member to thermally disconnect the first portion from the first additional thermal shield.
